(19) United States
(12) Patent Application Publication
(10) Pub. No.: US 2024/0095022 A1
(43) Pub. Date: Mar. 21, 2024

(54) HOTFIX METHOD, APPARATUS, DEVICE AND STORAGE MEDIUM

(71) Applicant: Beijing Bytedance Network Technology Co., Ltd., Beijing (CN)

(72) Inventor: Juncheng WEI, Beijing (CN)

(21) Appl. No.: 18/263,678

(22) PCT Filed: Feb. 22, 2022
(86) PCT No.: PCT/CN2022/077181

§ 371 Date: Jul. 31, 2023

(30) Foreign Application Priority Data
Mar. 16, 2021 (CN) 202110282350.1

(51) Int. Cl. G06F 8/656; G06F 8/41; G06F 21/14

(52) U.S. Cl. CPC G06F 8/656; G06F 8/41; G06F 21/14

(57) ABSTRACT

A hotfix method, an apparatus, a device and a storage medium are provided in embodiments of the present disclosure. The method includes: compiling a software development kit (SDK) for a hotfix; searching for a target file for storing a keep rule used during code obfuscation; searching for content that needs to be kept in the SDK, and generating an updated keep rule based on the content; updating the keep rule in the target file to the updated keep rule, and generating a binary archive file; where the binary archive file is used for providing a hotfix function for a target application accessing the SDK.

### CROSS-REFERENCE TO RELATED APPLICATION

This disclosure is a National Stage of International Application PCT/CN2022/077181, filed on Feb. 22, 2022, which claims priority to Chinese Patent Application No. 202110282350.1, filed on Mar. 16, 2021 and entitled “HOTFIX METHOD, APPARATUS, DEVICE AND STORAGE MEDIUM”, both of which are hereby incorporated by reference in their entireties.

### TECHNICAL FIELD

Embodiments of the present disclosure relate to the field of computer technologies and, in particular, to a hotfix method, an apparatus, a device and a storage medium.

### BACKGROUND

A hotfix is a method for fixing a software version defect at a low cost by issuing a patch (patch, i.e., a patch for fixing a bug) to achieve fixing online. In almost all the existing hotfix methods, when an application (App, application) is started on a client, a request is actively sends to a server to check whether there is a hotfix script, and if there is a script, the script is downloaded and executed.

A common method for a hotfix solution at a software development kit (SDK) level includes an SDK hotfix solution using a hook application (hookApp) compiling process or a hotfix solution within an optional range using a self-code (project_only).

### SUMMARY

In a first aspect, an embodiment of the present disclosure provides a hotfix method, including:
compiling a software development kit (SDK) for a hotfix;
searching for a target file for storing a keep rule used during code obfuscation;
searching for content that needs to be kept in a hotfix SDK, and generating an updated keep rule based on the content; and
updating the keep rule in the target file to the updated keep rule, and generating a binary archive file;
where the binary archive file is used for providing a hotfix function for a target application accessing the hotfix SDK.

In a second aspect, an embodiment of the present disclosure provides a hotfix method, including:
acquiring a compiled hotfix SDK and a target file including an updated keep rule in a binary archive file;
accessing the compiled hotfix SDK, acquiring the updated keep rule from the target file, and performing secondary obfuscation according to the updated keep rule; and
performing, by using a hotfix function of the compiled hotfix SDK, a hotfix on a secondary obfuscated code, where a code of the compiled hotfix SDK is an obfuscated code.

In a third aspect, an embodiment of the present disclosure provides a hotfix apparatus, including:
a compiling module, configured to compile a software development kit (SDK) for a hotfix;
a first searching module, configured to search for a target file for storing a keep rule used during code obfuscation;
a second searching module, configured to search for content that needs to be kept in a hotfix SDK, and generate an updated keep rule based on the content; and
an updating module, configured to update the keep rule in the target file to the updated keep rule, and generate a binary archive file;
where the binary archive file is used for providing a hotfix function for a target application accessing the hotfix SDK.

In a fourth aspect, an embodiment of the present disclosure provides a hotfix apparatus, including:
an acquiring module, configured to acquire a compiled hotfix SDK and a target file including an updated keep rule in a binary archive file;
a processing module, configured to access the compiled hotfix SDK, acquire the updated keep rule from the target file, and perform secondary obfuscation according to the updated keep rule; and a hotfix module, configured to perform, by using a hotfix function of the compiled hotfix SDK, a hotfix on a secondary obfuscated code, where a code of the compiled hotfix SDK is an obfuscated code.

In a fifth aspect, an embodiment of the present disclosure provides an electronic device, including: at least one processor, a memory, and a communication interface;
the communication interface is used to communicate with a network device;
the memory stores computer-executed instructions;
the at least one processor executes the computer-executed instructions stored in the memory, causing the at least one processor to execute the hotfix method in the above first and second aspects.

In a sixth aspect, an embodiment of the present disclosure provides a computer-readable storage medium. The computer readable storage medium stores computer-executed instructions. When a processor executes the computer-executed instructions, the hotfix method in the above first and second aspects is implemented.

In a seventh aspect, an embodiment of the present disclosure provides a computer program product including a computer program, when the computer program is executed by a processor, the hotfix method in the above first and second aspects is implemented.

In an eighth aspect, an embodiment of the present disclosure provides a computer program, when the computer program is executed by a processor, the hotfix method in the above first and second aspects is implemented.

### BRIEF DESCRIPTION OF DRAWINGS

To describe technical solutions in embodiments of the present disclosure or in the prior art more clearly, the following briefly introduces accompanying drawings required for describing the embodiments or the prior art. Apparently, the accompanying drawings in the following description show some embodiments of the present disclosure, and other drawings may also be obtained by a person of ordinary skill in the art according to these drawings without creative efforts.

FIG. 1 is a scenario schematic diagram of a hotfix method according to an embodiment of the present disclosure.

FIG. 2 is a schematic flowchart of a hotfix method according to an embodiment of the present disclosure.

FIG. 3 is a schematic flowchart of a hotfix method according to another embodiment of the present disclosure.

FIG. 4 is a schematic flowchart of a hotfix method according to still another embodiment of the present disclosure.

FIG. 5 is a schematic flowchart of a hotfix method according to another embodiment of the present disclosure.

FIG. 6 is a structural block diagram of a hotfix apparatus according to an embodiment of the present disclosure.

FIG. 7 is a structural block diagram of a hotfix apparatus according to still another embodiment of the present disclosure.

FIG. 8 is a hardware structural schematic diagram of an electronic device according to an embodiment of the present disclosure.

### DESCRIPTION OF EMBODIMENTS

Embodiments of the present disclosure will be described in more detail below with reference to accompanying drawings. Although certain embodiments of the present disclosure are shown in the accompanying drawings, it should be understood that the present disclosure may be implemented in various forms and should not be construed as being limited to the embodiments set forth herein, but rather these embodiments are provided for a thorough and comprehensive understanding of the present disclosure. It should be understood that the drawings and the embodiments of the present disclosure are only for illustrative purposes and are not intended to limit the scope of the present disclosure.

It should be understood that, steps recorded in method implementations of the present disclosure may be executed in different orders, and/or executed in parallel. Furthermore, the method implementations may include additional steps and/or omit executing illustrated steps. The scope of the present disclosure is not limited in this respect.

The term “including” and variations thereof, as used herein, is inclusive, i.e., “including but not limited to”. The term “based on” is “based at least in part on”. The term “one embodiment” means “at least one embodiment”, the term “another embodiment” means “at least one further embodiment”; and the term “some embodiments” means “at least some embodiments”. Relevant definitions of other terms will be given in the following description.

It should be noted that, concepts such as “first” and “second” mentioned in the present disclosure are only used to distinguish different apparatuses, modules or units, and are not intended to limit the order or interdependence of the function performed by these apparatuses, modules or units.

It should be noted that the modifications of “a” and “a plurality of” mentioned in the present disclosure are illustrative rather than restrictive, and a person skilled in the art should understand that they should be understood as “one or more” unless the context clearly indicates otherwise.

The names of messages or information interacted between a plurality of apparatuses or modules in the implementations of the present disclosure are only for illustrative purposes, and are not intended to limit the scope of these messages or information.

Generally, an accessing-party app needs to perform secondary obfuscation when accessing an SDK, but the secondary obfuscation may cause unavailability of a hot patch, a hotfix failure, may even lead to an app accessing failure. In the prior art, by providing a corresponding keep rule, the accessing-party app adds the corresponding keep (i.e., non-obfuscation or keep) rule when accessing the SDK. However, this may cause the following defects: if the keep rule is provided, manual keep (i.e., non-obfuscation) during the application accessing is relied on, and if the app omits other related rules, problems such as an invalid hotfix, flash back of the app and the like may be caused, the SDK and the app need to manually maintain the keep rule together each time an SDK version is updated, and the maintenance cost is very high.

In the prior art, generally, an accessing-party app has a requirement for secondary obfuscation, that is, the secondary obfuscation generally needs to be performed. However, in the current SDK hotfix solution, after the accessing-party app performs the secondary obfuscation, a hotfix function of an SDK becomes unavailable, and possibility of flash back (or collapse) will even increase. Even if the availability after the secondary obfuscation is ensured by maintaining the keep rule, the maintenance still needs to be performed by the SDK and the accessing-party application together, and there is high intrusiveness into the accessing-party app and a high maintenance cost.

In order to solve the described problem, the technical concept of the present disclosure is: characteristics of a binary archive file of an Android library project (Android Archive, AAR) that, there is a proguard.txt in aar (i.e., AAR) is used, and content of a keep rule generated in a process of compiling an SDK can be stored by using the proguard.txt. In this way, when accessing the SDK, by using the keep rule in the proguard.txt, the accessing-party app will learn a self-code and an external dependency code which are non-obfuscated, where the self-code has been obfuscated once, and will not cause leakage of the logic of the self-code. In this way, the accessing-party app can use the hotfix function of the SDK without awareness during secondary obfuscation, thereby expanding an applicability scope and usability of an SDK hotfix, and ensuring code security of the accessing-party app.

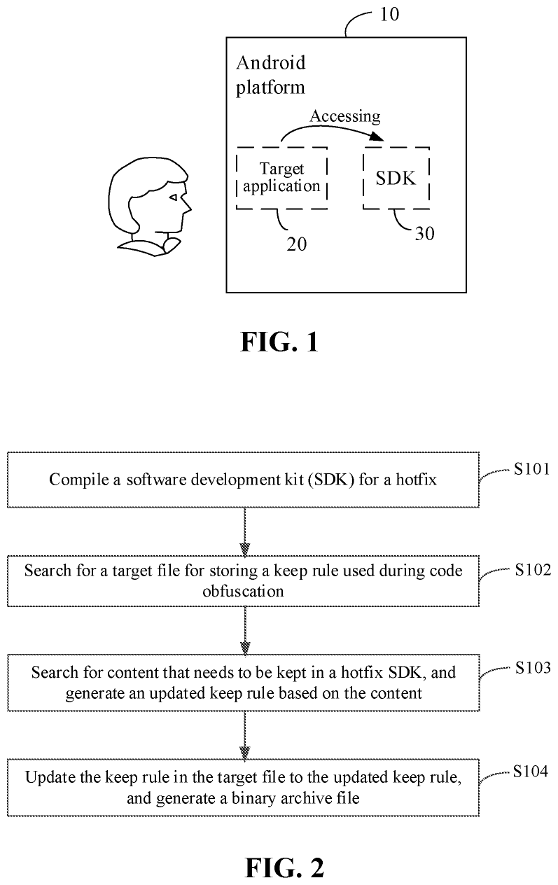

Please refer to FIG. 1. FIG. 1 is a scenario schematic diagram of a hotfix method according to an embodiment of the present disclosure. In this scenario, it is ensured in the hotfix method of the present disclosure that, on an Android platform 10, an accessing-party app (referred to as a target application 20 here) can still perform an SDK 30 hotfix during secondary obfuscation, there is no intrusiveness into the accessing-party app, and there is no non-obfuscation requirement, and a keep rule related to an SDK hotfix does not need to be updated synchronously when the SDK 30 is updated.

Please refer to FIG. 2. FIG. 2 is a schematic flowchart of a hotfix method according to an embodiment of the present disclosure. The method according to the embodiment of the present disclosure may be applied to a terminal device or a server. The execution subject is not limited in the embodiment of the present disclosure. The hotfix method includes the following.

Step S101, compile a software development kit (SDK) for a hotfix.

The embodiment of the present disclosure can be applied to an Android platform. On the Android platform, if an accessing-party app wants to normally use a hotfix function of an accessed SDK, it is necessary to add non-obfuscated content (which is referred to as a keep rule herein) to the aar in the process of generating or compiling the SDK, so that when accessing the SDK, the accessing-party app removes the non-obfuscated content according to the added keep rule (namely, a non-obfuscation rule or a keep rule), and then performs secondary obfuscation. Thus, the accessing-party app uses the hotfix function of the SDK after the secondary obfuscation, the code can be recognized to enable a hotfix, i.e., the hotfix function of the SDK can still be used.

Specifically, in response to an instruction to execute an operation of compiling an SDK, the operation of compiling the SDK is executed according to a preset compiling language. In the process of compiling the SDK, the required keep rule is updated in the proguard.txt of the aar, i.e., in the target file, and what is stored in the target file is the keep rule, that is, the non-obfuscated content.

S102, search for a target file for storing a keep rule used during code obfuscation.

In the embodiment of the present disclosure, during the process of compiling, the keep rule may be stored in the proguard.txt by searching for the proguard.txt of the aar, i.e., the target file.

S103, search for content that needs to be kept in a hotfix SDK, and generate an updated keep rule based on the content.

S104, update the keep rule in the target file to the updated keep rule, and generate a binary archive file.

The binary archive file is used for providing a hotfix function for a target application accessing the SDK.

In the embodiment of the present disclosure, in the compiling process, the content that needs to be kept in the SDK may be searched for, then the content thereof is generated as the updated keep rule (or the non-obfuscation rule), the updated keep rule is synchronize to the target file, and the binary archive file is generated.

In practical applications, the accessing-party app is notified to access the compiled SDK on the Android platform. When accessing the compiled SDK, the target application determines whether a keep rule exists in the compiled SDK by searching. If yes, the content of the keep rule is directly acquired, then, secondary obfuscation is performed on the app self based on the keep rule. Thus, it is ensured that the obfuscated code in the SDK is not subjected to secondary obfuscation any more, avoiding that the accessing-party app cannot use the hotfix function of the SDK. Here, the accessing-party app is not limited, and there is no non-obfuscation requirement.

In the hotfix method provided by the present disclosure, by compiling the software development kit (SDK) for the hotfix, in a compiling process, searching for the target file for storing the keep rule used during code obfuscation, searching for the content that needs to be kept in the SDK, and generating the updated keep rule based on the content, then updating the keep rule in the target file to the updated keep rule, and generating the binary archive file, to provide a hotfix function for the target application accessing the SDK, therefore, when the accessing-party app (i.e., the target application) needs to access the SDK, the target application may directly acquire the content that needs not to be obfuscated (i.e., the keep content) from the target file, thereby performing a hotfix on the secondary obfuscated code by using the hotfix function of the SDK. The hotfix function of the SDK can be used without requiring the target application to perform an additional operation. The problem of intrusiveness of an SDK hotfix into the target application is solved, and the method is applicable to a hotfix with or without a non-obfuscation requirement, the applicability scope of the SDK hotfix is expanded.

In practical applications, the object of obfuscation is not to leak the code, so as to avoid leakage of the logic of the code. According to the embodiments of the present disclosure, a solution is adopted to ensure that an application can still use a hotfix function of the SDK after accessing the SDK and being secondary obfuscated. The solution has no intrusiveness into the accessing-party app and has no requirement for non-obfuscation, and does not need to synchronously update a keep rule related to an SDK hotfix when updating the SDK. Furthermore, there is no continuous maintenance cost for the SDK, thereby reducing the accessing cost for a common application to access the hotfix SDK.

In an embodiment of the present disclosure, by utilizing the characteristics of the aar that there is a proguard.txt in the aar, in which a keep rule required by the aar is listed, and in the process of compiling an SDK, the content required by the keep rule is updated into this file. Therefore, if the content of the keep rule needs to be added into the target file, it is required to first find the position of an intermediate product—proguard.txt generated in the process of compiling the SDK. Based on the above embodiments, the embodiment of the present disclosure describes in detail how to acquire the position. Searching for the target file for storing the keep rule used during code obfuscation may be implemented by the following steps:
searching for the position of the target file for storing the keep rule used during code obfuscation in the aar.

Correspondingly, updating the keep rule in the target file to the updated keep rule may be implemented by the following steps:
adding a first code and a dependency code into the target file according to the found position of the target file.

In the embodiment of the present disclosure, through a task (i.e., hook Merge Consumer Proguard Files Task) in an obfuscation process, the position where the file proguard.txt finally generated in the aar in the compiling process is found, where the position is a position of the target file for storing the content of the keep rule corresponding to the SDK, that is, a position of the target file for storing the keep rule used during code obfuscation.

After the position of the target file is found, the first code and the dependency code are added into the target file according to the position of the target file.

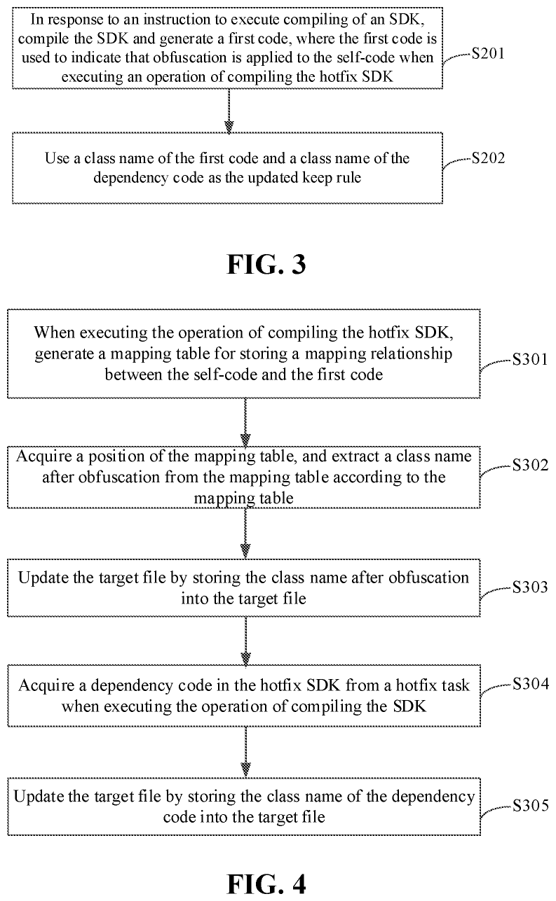

In an embodiment of the present disclosure, after the target file is found, how to determine and add non-obfuscated content is shown in FIG. 3. FIG. 3 is a schematic flowchart of a hotfix method according to another embodiment of the present disclosure. The embodiment of the present disclosure describes the hotfix method in detail on the basis of the foregoing embodiments. Before generating the binary archive file, the method further includes the following.

S201, in response to an instruction to execute compiling of an SDK, compile the SDK and generate a first code, where the first code is used to indicate that obfuscation is applied to the self-code when executing an operation of compiling the hotfix SDK.

S202, use a class name of the first code and a class name of the dependency code as the updated keep rule.

The hotfix SDK (herein referred to as a software development kit SDK for the hotfix, or directly referred to as the SDK) includes a self-code and a dependent code other than the self-code.

In the embodiment of the present disclosure, during the process of compiling the SDK, in order to ensure no leakage of a code, the code of the SDK needs to be obfuscated, and the obfuscated code is a simple code and cannot be read. When executing an operation of compiling the SDK, after obfuscation is applied to the self-code of the SDK, the first code is generated. Whether to obfuscate the dependency code except the self-code in the SDK is not limited herein. It is merely necessary to use the self-code to which obfuscation is applied when performing the operation of compiling the SDK and the dependency code in the SDK as the content of the keep rule, that is, the content that does not need to be obfuscated, and store the updated keep rule generated based on the content, that is, the class name of the first code and the class name of the dependency code, in the proguard.txt file.

The dependency code may be a code in other SDKs, where the code in other SDKs may be a code that has not been obfuscated and/or an obfuscated code, in the other hotfix SDKs.

In an embodiment of the present disclosure, how to store the updated keep rule generated when compiling the SDK into the target file is as shown in FIG. 4. FIG. 4 is a schematic flowchart of a hotfix method according to still another embodiment of the present disclosure. In the embodiment of the present disclosure, on the basis of the above embodiments, for example, on the basis of the embodiment as shown in FIG. 3, S104 is described in detail. The updating the keep rule in the target file to the updated keep rule includes the following.

S301, when executing the operation of compiling the hotfix SDK, generate a mapping table for storing a mapping relationship between the self-code and the first code.

S302, acquire a position of the mapping table, and extract, a class name after obfuscation, from the mapping table according to the mapping table.

S303, update the target file by storing the class name after obfuscation into the target file.

In the embodiment of the present disclosure, in the process of compiling the SDK, a print Mapping table will be generated, and the mapping table is used for storing the self-code and the code after the self-code is obfuscated, etc. After code obfuscation, the position of the print Mapping table is found first, then the class name after obfuscation within the project_only (i.e., internal code or self-code, used for indicating the self-code of the SDK) range is extracted from the print Mapping table according to the mapping relationship in the mapping table. The class name after obfuscation is used as a material of the keep rule and stored in the target file.

S304, acquire, a dependency code in the hotfix SDK, from a hotfix task when executing the operation of compiling the SDK.

S305, update the target file by storing the class name of the dependency code into the target file.

In the embodiment of the present disclosure, the class name of the dependency code is acquired by means of a hotfix stub process. Specifically, in the compiling process, an information transmission method between tasks is that, an output of a previous task, serves as an input of a next task. The found class name of the dependency code outside the project_only range in the SDK is stored in a related file, i.e., the proguard.txt file, and serves as a material of the keep rule.

Specifically, the material in the above steps is updated into the found file through the hotfix task, and when the compiling of the aar or the SDK is completed, the proguard.txt therein has already been updated. All obfuscation rules related to the SDK hotfix have been updated in the proguard.txt in the aar. The accessing-party app does not need an additional operation when accessing.

In an embodiment of the present disclosure, how to enable the accessing-party app to perform secondary obfuscation based on the keep rule may include the following steps:
instructing the target application to access the compiled hotfix SDK, so that the target application performs secondary obfuscation on other codes except content of the keep rule in all codes of the accessed compiled hotfix SDK.

In the embodiment of the present disclosure, when accessing, the accessing-party app will learn the self-code and an external dependency code (i.e., the dependency code) needing to be kept, by using the keep rule in the proguard.txt, a product generated in the hotfix SDK. The self-code has been obfuscated once, and will not cause leakage of the logic of the self-code. In this way, the accessing-party app can perform secondary obfuscation during accessing, and no additional keep rule needs to be added for the hotfix SDK.

In the embodiment of the present disclosure, the requirement on intrusiveness of the SDK hotfix into the accessing-party app is solved, so that after secondary obfuscation, the accessing-party application can use a hotfix function of the SDK without an additional operation, thereby expanding the applicability scope and usability of the SDK hotfix. An accessing party can use the hotfix function of the SDK without awareness during secondary obfuscation, thereby not only expanding the applicability scope and usability of the SDK hotfix, but also guaranteeing the code security of the accessing-party app. There is no intrusiveness into the accessing-party app and no non-obfuscation requirement for the accessing-party app, and it is unnecessary to synchronously update the keep rule related to the SDK hotfix when updating the SDK, and there is no continuous maintenance cost on the SDK side.

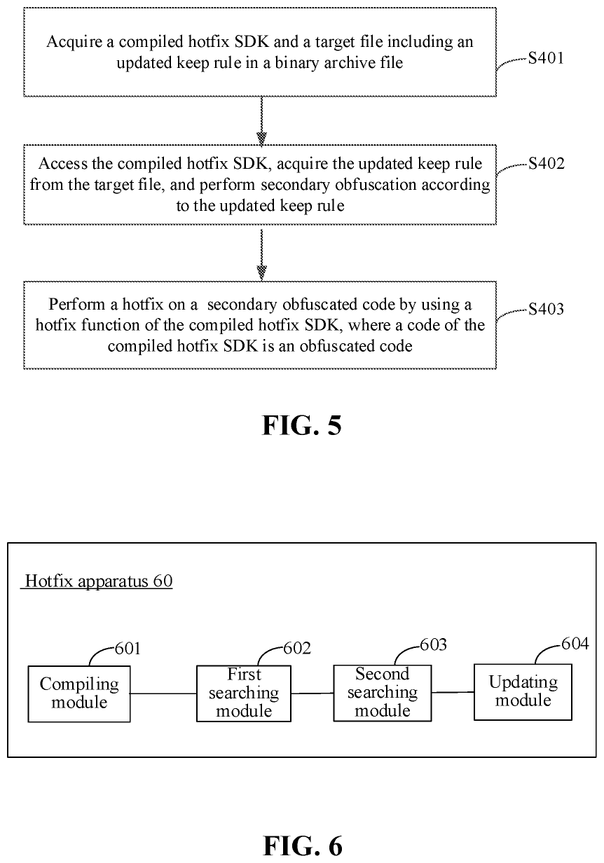

Please refer to FIG. 5. FIG. 5 is a schematic flowchart of a hotfix method according to another embodiment of the present disclosure. The method according to the embodiment of the present disclosure may be applied to a terminal device installed with a target application (referred to as an accessing-party app herein). The hotfix method may include the following.

S401, acquire a compiled hotfix SDK and a target file including an updated keep rule in a binary archive file.

S402, access the compiled hotfix SDK, acquire the updated keep rule from the target file, and perform secondary obfuscation according to the updated keep rule.

S403, perform a hotfix on a secondary obfuscated code, by using a hotfix function of the compiled hotfix SDK, where a code of the compiled hotfix SDK is an obfuscated code.

In the embodiment of the present disclosure, when the target application needs to access the hotfix SDK, the compiled hotfix SDK and the target file including the updated keep rule are first acquired from the binary archive file. Then, when accessing the compiled hotfix SDK, the updated keep rule needs to be acquired from the target file, and secondary obfuscation of the code is performed according to the updated keep rule to obtain the secondary obfuscated code. And then a hotfix is performed on the secondary obfuscated code, by using the hotfix function of the hotfix SDK. Therefore, in the embodiment of the present disclosure, the generated keep rule is updated in the file by using the proguard.txt file included in the characteristics of the aar. When accessing, the accessing-party app directly acquires the content that does not need to be obfuscated from the file, and then performs the hotfix on the secondary obfuscated code, by using the hotfix function of the SDK. It is unnecessary to perform an additional operation for the target application to use the hotfix function of the SDK, thereby solving the problem of intrusiveness of the SDK hotfix into the target application. At the same time, the method is applicable to a hotfix with or without a non-obfuscation requirement, and expands an applicability scope of the SDK hotfix.

In an embodiment of the present disclosure, accessing the compiled hotfix SDK, acquiring the updated keep rule from the target file, and performing the secondary obfuscation according to the updated keep rule may be implemented through the following steps.

Step a1, access the compiled hotfix SDK.

Step a2, perform secondary obfuscation on other codes except the updated keep rule in all codes of the accessed compiled hotfix SDK.

In the embodiment of the present disclosure, by updating or optimizing the keep rule, when accessing the compiled hotfix SDK, the target application can perform secondary obfuscation on other codes except the updated keep rule among all codes of the accessed compiled hotfix SDK according to the updated keep rule. It is unnecessary to perform an additional operation for the target application to use the hotfix function of the SDK, thereby solving the problem of intrusiveness of the SDK hotfix into the target application. At the same time, the method is applicable to a hotfix with or without a non-obfuscation requirement, and expands an applicability scope of the SDK hotfix.

Corresponding to the hotfix method according to the above disclosed embodiments, FIG. 6 is a structural block diagram of a hotfix apparatus according to an embodiment of the present disclosure. For ease of description, only parts related to the embodiments of the present disclosure are shown. Referring to FIG. 6, a hotfix apparatus 60 includes: a compiling module 601, a first searching module 602, a second searching module 603 and an updating module 604. The compiling module 601 is configured to compile a software development kit SDK for a hotfix. The first searching module 602 is configured to search for a target file for storing a keep rule used during code obfuscation. The second searching module 603 is configured to search for content that needs to be kept in a hotfix SDK, and generate an updated keep rule based on the content. The updating module 604 is configured to update the keep rule in the target file to the updated keep rule, and generate a binary archive file; where the binary archive file is used for providing a hotfix function for a target application accessing the hotfix SDK.

The compiling module 601, the first searching module 602, the second searching module 603 and the updating module 604 provided in the embodiment of the present disclosure are configured to: compile the software development kit (SDK) for the hotfix, in the compiling process, search for the target file for storing the keep rule used during code obfuscation, and search for the content that needs to be kept in the SDK, and generate the updated keep rule based on the content; then update the keep rule in the target file to the updated keep rule, and generate the binary archive file, to provide a hotfix function for the target application accessing the SDK. Therefore, when an accessing-party app (i.e., the target application) needs to access the SDK, the target application may directly acquire content that needs not to be obfuscated (i.e., the keep content) from the target file. Thus, the hotfix is performed on the secondary obfuscated code, by using the hotfix function of the SDK. The hotfix function of the SDK can be used without requiring the target application to perform an additional operation. The problem of intrusiveness of the SDK hotfix into the target application is solved, and the solution is applicable to a hotfix with or without a non-obfuscation requirement at the same time, the applicability scope of the SDK hotfix is expanded.

The apparatus provided in the embodiment of the present disclosure can be used for implementing the technical solutions of the method embodiments corresponding to various possible designs of the first aspect and the first aspect. The implementation principle and the technical effect are similar, and are not repeated here in the embodiment of the present disclosure.

In an embodiment of the present disclosure, based on the above disclosed embodiments, the hotfix apparatus is described in detail. The hotfix SDK includes a self-code and a dependent code except the self-code. The apparatus further includes: an added content determining module, configured to: before the binary archive file is generated, in response to an instruction to execute compiling of the SDK, compile the SDK to generate a first code, where the first code is used to indicate that obfuscation is applied to a self-code when executing an operation of compiling the SDK; use a class name of the first code and a class name of the dependency code as the updated keeping rule.

In an embodiment of the present disclosure, based on the above disclosed embodiment, the updating module is described in detail in the embodiment of the present disclosure. The updating module is specifically configured to:
when the operation of compiling the hotfix SDK is executed, generate a mapping table for storing a mapping relationship between the self-code and the first code; acquire a position of the mapping table, and according to the mapping relationship, extract, a class name after obfuscation, from the mapping table; update the target file by storing the class name after obfuscation into the target file; acquire a dependency code in the hotfix SDK, from a hotfix task during execution of the operation of compiling the hotfix SDK; update the target file by storing the class name of the dependency code into the target file.

In an embodiment of the present disclosure, based on the above disclosed embodiments, the updating module is described in detail in the embodiment of the present disclosure. The updating module is further specifically configured to: add the first code and the dependency code into the target file according to the found position of the target file.

In an embodiment of the present disclosure, based on the above disclosed embodiments, the embodiment of the present disclosure describes the hotfix apparatus in detail. The dependency code is a code in other hotfix SDKs, and the code in the other hotfix SDKs is, a code that has not been obfuscated and/or an obfuscated code, in the other hotfix SDKs.

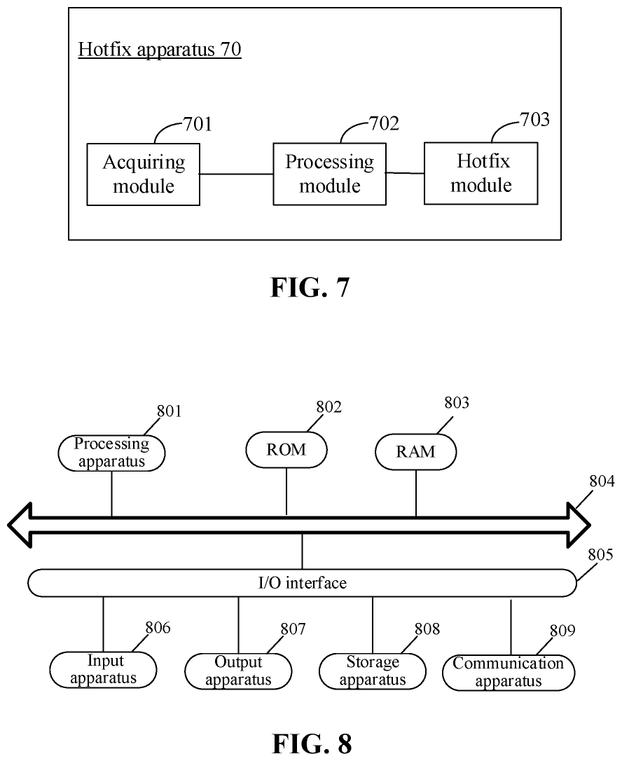

Corresponding to the hotfix method in the above disclosed embodiments, FIG. 7 is a structural block diagram of a hotfix apparatus according to still another embodiment of the present disclosure. For ease of description, only parts related to the embodiment of the present disclosure are shown. Referring to FIG. 7, a hotfix apparatus 70 includes: an acquiring module 701, a processing module 702, and a hotfix module 703. The acquiring module 701 is configured to acquire a compiled hotfix SDK and a target file including an updated keep rule in a binary archive file. The processing module 702 is configured to access the compiled hotfix SDK, acquire content of the updated keep rule from the target file, and perform secondary obfuscation according to the content of the updated keep rule. The hotfix module 703 is configured to perform a hotfix on a secondary obfuscated code by using a hotfix function of the compiled hotfix SDK, where a code of the compiled hotfix SDK is an obfuscated code.

The acquiring module 701, the processing module 702 and the hotfix module 703 provided in the embodiment of the present disclosure are configured to: update the generated keep rule in a file by using the proguard.txt file in the characteristics of the aar, and when accessing, an accessing-party app directly acquires content that needs not to be obfuscated, from the file. Thus, the hotfix is performed on the secondary obfuscated code, by using the hotfix function of the SDK. The hotfix function of the SDK can be used without requiring the target application to perform an additional operation. The problem of intrusiveness of the SDK hotfix into the target application is solved, and the solution is applicable to a hotfix with or without a non-obfuscation requirement, the applicability scope of the SDK hotfix is expanded.

The apparatus provided in the embodiment of the present disclosure can be used for implementing the technical solutions of the method embodiments corresponding to various possible designs of the second aspect and the second aspect. The implementation principle and the technical effect are similar, and are not repeated here in the embodiment of the present disclosure.

In an embodiment of the present disclosure, the processing module is specifically configured to: access the compiled hotfix SDK; and perform secondary obfuscation on other codes except the updated keep rule in all codes of the accessed compiled hotfix SDK.

Please refer to FIG. 8, which shows a structural schematic diagram of an electronic device suitable for implementing an embodiment of the present disclosure. The electronic device may be a terminal device or a server. The terminal device may include, but is not limited to, a mobile terminal such as a mobile phone, a laptop computer, a digital broadcast receiver, a personal digital assistant (PDA), a tablet computer (Portable Android Device, PAD), a portable multimedia player (Portable Media Player, PMP), a vehicle-mounted terminal (for example, a vehicle-mounted navigation terminal) and the like, and a fixed terminal such as a digital TV, a desktop computer and the like. The electronic device shown in FIG. 8 is merely an example and should not bring any limitation to the functions and scope of use of the embodiments of the present disclosure.

As shown in FIG. 8, the electronic device may include a processing apparatus (e.g., a central processor, a graphics processor, etc.) 801 that may perform various suitable actions and processing according to a program stored in a read only memory (ROM) 802 or a program loaded into a random access memory (RAM) 803 from a storage apparatus 808. In the RAM 803, various programs and data necessary for the operation of the electronic device are also stored. The processing apparatus 801, the ROM 802, and the RAM 803 are connected to each other via a bus 804. An input/output (I/O) interface 805 is also connected to the bus 804.

In general, the following apparatuses may be connected to the I/O interface 805: an input apparatus 806 including, for example, a touch screen, a touch pad, a keyboard, a mouse, a camera, a microphone, an accelerometer, a gyroscope and the like; an output apparatus 807 including, for example, a liquid crystal display (LCD), a speaker, a vibrator and the like; a storage apparatus 808 including, for example, a magnetic tape, a hard disk, and the like; and a communication apparatus 809. The communication apparatus 809 may allow the electronic device to perform wireless or wired communication with other devices to exchange data. Although FIG. 8 illustrates an electronic device with a variety of apparatuses, it is to be understood that it is not necessary that all of the illustrated apparatuses should be implemented or provided. More or fewer apparatuses may alternatively be implemented or provided.

In particular, the processes described above with reference to the flowcharts can be implemented as computer software programs in accordance with embodiments of the present disclosure. For example, an embodiment of the present disclosure includes a computer program product including a computer program carried on a computer-readable medium. The computer program includes program codes for executing the method as shown in the flowcharts. In such an embodiment, the computer program may be downloaded and installed from a network via communications apparatus 809, or installed from the storage apparatus 808, or installed from the ROM 802. When the computer program is executed by the processing apparatus 801, the described functions defined in the method embodiments of the present disclosure are executed.

It should be noted that, the computer-readable medium in the present disclosure may be a computer-readable signal medium or a computer-readable storage medium, or any combination thereof. The computer-readable storage medium may be, for example, but not limited to, an electronic, a magnetic, an optical, an electromagnetic, an infrared or a semiconductor system, apparatus or device, or any suitable combination of the foregoing. More specific examples of the computer-readable storage medium may include, but are not limited to, an electrical connection based on one or more wires, a portable computer diskette, a hard disk, a random access memory (RAM), a read only memory (ROM), an erasable programmable read only memory (Erasable Programmable ROM, EPROM or a Flash memory), an optical fiber, a portable compact disc read only memory (Compact Disc ROM, CD-ROM), an optical storage device, a magnetic storage device, or any suitable combination of the foregoing. In the present disclosure, the computer-readable storage medium may be any tangible medium that contains or stores a program for use by or in combination with an instruction execution system, apparatus or device. While in the present disclosure, the computer-readable signal medium may include data signals propagated in a baseband or as part of a carrier wave, in which computer-readable program codes are carried. Such propagated signals may take a variety of forms, including, but not limited to, an electromagnetic signal, an optical signal, or any suitable combination thereof. The computer-readable signal medium may also be any computer-readable medium that is not a computer-readable storage medium, and can send, propagate or transmit a program for use by or in combination with an instruction execution system, apparatus or device. Program codes contained on the computer-readable medium may be transmitted using any appropriate medium, including, but not limited to, a wireline, an optical fiber cable, radio frequency (radio frequency, RF), etc., or any suitable combination of the foregoing.

The computer-readable medium may be included in the electronic device, or may exist alone and not be installed in the electronic device.

The computer-readable medium carries one or more programs, and when the one or more programs are executed by the electronic device, the electronic device is caused to execute the method shown in the above embodiments.

Computer program codes for carrying out operations of the present disclosure may be written in one or more programming languages or any combination thereof, including an object oriented programming language such as Java, Smalltalk, C++ and a conventional procedural programming language such as C programming language or similar programming languages. The program codes may be executed entirely on a user computer, executed partly on the user computer, executed as a stand-alone software package, executed partly on the user computer and partly on a remote computer, or executed entirely on the remote computer or server. In the scenario involving the remote computer, the remote computer may be connected to the user computer through any type of network, including a local area network (LAN) or a wide area network (WAN), or may be connected to an external computer (for example, through the Internet of an Internet service provider).

The flowcharts and block diagrams in the accompanying drawings illustrate architectures, functionalities and operations of possible implementations of systems, methods and computer program products according to various embodiments of the present disclosure. In this regard, each block in the flowcharts or block diagrams may represent a module, a program segment, or a portion of codes, which includes one or more executable instructions for implementing specified logical function(s). It should also be noted that, in some alternative implementations, the functions noted in the blocks may be implemented in an order different from those noted in the drawings. For example, two blocks shown in succession may, in fact, be executed substantially concurrently, or the blocks may sometimes be executed in the reverse order, depending upon the involved functionality. It should also be noted that, each block of the block diagrams and/or flowcharts and combinations of blocks in the block diagrams and/or flowcharts can be implemented by special-purpose hardware-based systems that perform specified functions or operations, or combinations of special-purpose hardware and computer instructions.

The units involved in the embodiments of the present disclosure may be implemented through software or hardware. The name of a unit does not constitute a limitation to the unit itself in some cases.

The above functions described herein may be performed, at least in part, by one or more hardware logic components. For example, unrestrictedly, exemplary types of hardware logic components that can be used include: a Field Programmable Gate Array (FPGA), an Application Specific Integrated Circuit (ASIC), an Application Specific Standard Product (ASSP), a System on chip (SOC), a Complex Programmable Logic Device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, a magnetic, an optical, an electromagnetic, an infrared or a semiconductor system, apparatus or device, or any suitable combination of the foregoing. More specific examples of the machine-readable storage medium include an electrical connection based on one or more wires, a portable computer diskette, a hard disk, a random access memory (RAM), a read only memory (ROM), an erasable programmable read only memory (EPROM or a Flash memory), an optical fiber, a compact disc read only memory (CD-ROM), an optical storage device, a magnetic storage device, or any suitable combination of the foregoing.

An embodiment of the present disclosure provides a computer program product including a computer program, when the computer program is executed by a processor, the method in the above first and second aspects is implemented.

In a first aspect, an embodiment of the present disclosure provides a hotfix method, including:
compiling a software development kit (SDK) for a hotfix;
searching for a target file for storing a keep rule used during code obfuscation;
searching for content that needs to be kept in a hotfix SDK, and generating an updated keep rule based on the content; and
updating the keep rule in the target file to the updated keep rule, and generating a binary archive file;
where the binary archive file is used for providing a hotfix function for a target application accessing the hotfix SDK.

According to one or more embodiments of the present disclosure, the hotfix SDK includes a self-code and a dependency code except the self-code;
before the generating the binary archive file, the method further includes:
in response to an instruction to execute compiling of the hotfix SDK, compiling the hotfix SDK, and generating a first code, where the first code is used to indicate that obfuscation is applied to a self-code when executing an operation of compiling the hotfix SDK; and
using a class name of the first code and a class name of the dependency code as the updated keep rule.

According to one or more embodiments of the present disclosure, the updating the keep rule in the target file to the updated keep rule includes:
when executing the operation of compiling the hotfix SDK, generating a mapping table for storing a mapping relationship between the self-code and the first code;
acquiring a position of the mapping table, and extracting, a class name after obfuscation, from the mapping table according to the mapping relationship;
updating the target file by storing, the class name after obfuscation, into the target file;
acquiring, a dependency code in the hotfix SDK, from a hotfix task when executing the operation of compiling the hotfix SDK; and
updating the target file by storing the class name of the dependency code into the target file.

According to one or more embodiments of the present disclosure, the updating the keep rule in the target file to the updated keep rule includes:
adding the first code and the dependency code into the target file, according to a found position of the target file.

According to one or more embodiments of the present disclosure, the dependency code is a code in other hotfix SDKs, and the code in the other hotfix SDKs is, a code that has not been obfuscated and/or an obfuscated code, in the other hotfix SDKs.

In a second aspect, an embodiment of the present disclosure provides hotfix method, including:
acquiring a compiled hotfix SDK and a target file including an updated keep rule in a binary archive file;
accessing the compiled hotfix SDK, acquiring the updated keep rule from the target file, and performing secondary obfuscation according to the updated keep rule; and
performing, by using a hotfix function of the compiled hotfix SDK, a hotfix on a secondary obfuscated code, where a code of the compiled hotfix SDK is an obfuscated code.

According to one or more embodiments of the present disclosure, the accessing the compiled hotfix SDK, acquiring the updated keep rule from the target file, and performing the secondary obfuscation according to the updated keep rule includes:
accessing the compiled hotfix SDK; and
performing the secondary obfuscation on other codes except the updated keep rule in all codes of the accessed compiled hotfix SDK.

In a third aspect, an embodiment of the present disclosure provides a hotfix apparatus, including:
a compiling module, configured to compile a software development kit (SDK) for a hotfix;
a first searching module, configured to search for a target file for storing a keep rule used during code obfuscation;
a second searching module, configured to search for content that needs to be kept in a hotfix SDK, and generate an updated keep rule based on the content; and
an updating module, configured to update the keep rule in the target file to the updated keep rule, and generate a binary archive file;
where the binary archive file is used for providing a hotfix function for a target application accessing the hotfix SDK.

According to one or more embodiments of the present disclosure, the hotfix SDK includes a self-code and a dependency code except the self-code; the apparatus further includes: an added content determining module, configured to: before the binary archive file is generated, in response to an instruction to execute compiling of the SDK, compile the SDK, and generate a first code, where the first code is used to indicate that obfuscation is applied to a self-code when executing an operation of compiling the SDK; use a class name of the first code and a class name of the dependency code as the updated keep rule.

According to one or more embodiments of the present disclosure, the updating module is specifically configured to: when the operation of compiling the hotfix SDK is executed, generate a mapping table for storing a mapping relationship between the self-code and the first code; acquire a position of the mapping table, and extract a class name after obfuscation, from the mapping table according to the mapping relationship; update the target file by storing the class name after obfuscation into the target file; acquire a dependency code in the hotfix SDK, from a hotfix task during execution of the operation of compiling the hotfix SDK; update the target file by storing the class name of the dependency code into the target file.

According to one or more embodiments of the present disclosure, the updating module is further specifically configured to: add the first code and the dependency code into the target file according to a found position of the target file.

According to one or more embodiments of the present disclosure, the dependency code is a code in other hotfix SDKs, and the code in the other hotfix SDKs is, a code that has not been obfuscated and/or an obfuscated code, in the other hotfix SDKs.

In a fourth aspect, an embodiment of the present disclosure provides hotfix apparatus, including:
an acquiring module, configured to acquire a compiled hotfix SDK and a target file including an updated keep rule in a binary archive file;
a processing module, configured to access the compiled hotfix SDK, acquire the updated keep rule from the target file, and perform secondary obfuscation according to the updated keep rule; and
a hotfix module, configured to perform, by using a hotfix function of the compiled hotfix SDK, a hotfix on a secondary obfuscated code, where a code of the compiled hotfix SDK is an obfuscated code.

According to one or more embodiments of the present disclosure, the processing module is specifically configured to: access the compiled hotfix SDK; and perform secondary obfuscation on other codes except the updated keep rule in all codes of the accessed compiled hotfix SDK.

In a fifth aspect, an embodiment of the present disclosure provides an electronic device, including: at least one processor, a memory, and a communications interface;
the communications interface is used to communicate with a network device;
the memory stores computer-executed instructions;
the at least one processor executes the computer-executed instructions stored in the memory, causing the at least one processor to execute the hotfix method in the above first and second aspects.

In a sixth aspect, an embodiment of the present disclosure provides a computer-readable storage medium. The computer readable storage medium stores computer-executable instructions. When a processor executes the computer-executable instructions, the hotfix method in the above first and second aspects is implemented.

In a seventh aspect, an embodiment of the present disclosure provides a computer program product including a computer program, when the computer program is executed by a processor, the hotfix method in the above first and second aspects is implemented.

In an eighth aspect, an embodiment of the present disclosure provides a computer program, when the computer program is executed by a processor, the hotfix method in the above first and second aspects is implemented.

The foregoing description is merely illustrative of the preferred embodiments of the present disclosure and of the technical principles applied thereto. It should be appreciated by a person skilled in the art that, the disclosure scope of the present disclosure is not limited to the technical solutions formed by specific combinations of the described technical features, and meanwhile should also cover other technical solutions formed by any combination of the described technical features or equivalent features thereof without departing from the described disclosed concept, for example, technical solutions formed by substituting the above features and technical features having similar functions as disclosed in the present disclosure (but not limited thereto) for one another.

In addition, while operations are depicted in a particular order, it should not be understood as that the operations need to be performed in a particular order as shown or in a sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented separately or in any suitable sub-combination in a plurality of embodiments.

Although the subject matter has been described in language specific to structural features and/or method logical acts, it should be understood that, the subject matter defined in the appended claims is not necessarily limited to the specific features or acts described above. Rather, the specific features and acts described above are merely illustrative forms for implementing the claims.

What is claimed is:

1. A hotfix method, wherein the method comprises:
compiling a software development kit (SDK) for a hotfix;
searching for a target file for storing a keep rule used during code obfuscation;
searching for content that needs to be kept in a hotfix SDK, and generating an updated keep rule based on the content; and
updating the keep rule in the target file to the updated keep rule, and generating a binary archive file;
wherein the binary archive file is used for providing a hotfix function for a target application accessing the hotfix SDK.

2. The method according to claim 1, wherein the hotfix SDK comprises a self-code and a dependency code except the self-code;
before the generating the binary archive file, the method further comprises:
in response to an instruction to execute compiling of the hotfix SDK, compiling the hotfix SDK, and generating a first code, wherein the first code is used to indicate that obfuscation is applied to a self-code when executing an operation of compiling the hotfix SDK; and
using a class name of the first code and a class name of the dependency code as the updated keep rule.

3. The method according to claim 2, wherein the updating the keep rule in the target file to the updated keep rule comprises:
when executing the operation of compiling the hotfix SDK, generating a mapping table for storing a mapping relationship between the self-code and the first code;
acquiring a position of the mapping table, and extracting, a class name after obfuscation, from the mapping table, according to the mapping relationship;
updating the target file by storing, the class name after obfuscation, into the target file;
acquiring, a dependency code in the hotfix SDK, from a hotfix task when executing the operation of compiling the hotfix SDK; and
updating the target file by storing the class name of the dependency code into the target file.

4. The method according to claim 2, wherein the updating the keep rule in the target file to the updated keep rule comprises:
adding the first code and the dependency code into the target file, according to a found position of the target file.

5. The method according to claim 4, wherein the dependency code is a code in other hotfix SDKs, and the code in the other hotfix SDKs is at least one of the following: a code that has not been obfuscated in the other hotfix SDKs, an obfuscated code in the other hotfix SDKs.

6. A hotfix method, comprising:
acquiring a compiled hotfix SDK and a target file comprising an updated keep rule in a binary archive file;
accessing the compiled hotfix SDK, acquiring the updated keep rule from the target file, and performing secondary obfuscation according to the updated keep rule, and
performing, by using a hotfix function of the compiled hotfix SDK, a hotfix on a secondary obfuscated code, wherein a code of the compiled hotfix SDK is an obfuscated code.

7. The method according to claim 6, wherein the accessing the compiled hotfix SDK, acquiring the updated keep rule from the target file, and performing the secondary obfuscation according to the updated keep rule comprises:
accessing the compiled hotfix SDK; and
performing the secondary obfuscation on other codes except the updated keep rule in all codes of the accessed compiled hotfix SDK.

8-9. (canceled)

10. An electronic device, comprising: at least one processor, a memory, and a communication interface;
wherein the communication interface is used to communicate with a network device;
the memory stores computer-executed instructions;
the at least one processor executes the computer-executed instructions stored in the memory, causing the at least one processor to:
compile a software development kit (SDK) for a hotfix;
search for a target file for storing a keep rule used during code obfuscation;
search for content that needs to be kept in a hotfix SDK, and generate an updated keep rule based on the content; and
update the keep rule in the target file to the updated keep rule, and generate a binary archive file;
wherein the binary archive file is used for providing a hotfix function for a target application accessing the hotfix SDK.

11. A non-transitory computer-readable storage medium, wherein the computer-readable storage medium stores computer-executed instructions, and when a processor executes the computer-executed instructions, the hotfix method according to claim 1 is implemented.

12-13. (canceled)

14. A non-transitory computer-readable storage medium, wherein the computer-readable storage medium stores computer-executed instructions, and when a processor executes the computer-executed instructions, the hotfix method according to claim 6 is implemented.

15. The electronic device according to claim 10, wherein the hotfix SDK comprises a self-code and a dependency code except the self-code;
before generating the binary archive file, the at least one processor is caused to:
in response to an instruction to execute compiling of the hotfix SDK, compile the hotfix SDK, and generate a first code, wherein the first code is used to indicate that obfuscation is applied to a self-code when executing an operation of compiling the hotfix SDK; and
use a class name of the first code and a class name of the dependency code as the updated keep rule.

16. The electronic device according to claim 15, wherein the at least one processor is caused to:
when executing the operation of compiling the hotfix SDK, generate a mapping table for storing a mapping relationship between the self-code and the first code;
acquire a position of the mapping table, and extract, a class name after obfuscation, from the mapping table, according to the mapping relationship;
update the target file by storing, the class name after obfuscation, into the target file;
acquire, a dependency code in the hotfix SDK, from a hotfix task when executing the operation of compiling the hotfix SDK; and
update the target file by storing the class name of the dependency code into the target file.

17. The electronic device according to claim 15, wherein the at least one processor is caused to:
add the first code and the dependency code into the target file, according to a found position of the target file.

18. The electronic device according to claim 17, wherein the dependency code is a code in other hotfix SDKs, and the code in the other hotfix SDKs is at least one of the following: a code that has not been obfuscated in the other hotfix SDKs, an obfuscated code in the other hotfix SDKs.

19. An electronic device, comprising: at least one processor, a memory, and a communication interface;
wherein the communication interface is used to communicate with a network device;
the memory stores computer-executed instructions;
the at least one processor executes the computer-executed instructions stored in the memory, causing the at least one processor to execute the hotfix method according to claim 6.
